(19) United States
(12) Patent Application Publication
(10) Pub. No.: US 2009/0244287 A1
(43) Pub. Date: Oct. 1, 2009

(54) VIDEO MONITORING SYSTEM

(76) Inventors: Eric Pearson, Markham (CA); Adam Porter, Stouffville (CA); Paul Georges Oushalkas, Markham (CA)

Correspondence Address: DIMOCK STRATTON LLP, 20 QUEEN STREET WEST SUITE 3202, BOX 102, TORONTO, ON, M5H 3R3, CA

(21) Appl. No.: 12/060,562

(22) Filed: Apr. 1, 2008

(51) Int. Cl. H04N 7/18

(52) U.S. Cl. 348/159; 348/E07.086

(57) ABSTRACT

A video monitoring system for monitoring one or more video cameras. The video cameras each supply a video stream to a hub. A computer in communication with the hub obtains information from each of the video cameras and allows a user to arrange the video streams on one or more video displays. Multiple video streams may be displayed on a single video display and a single video stream may be displayed on multiple video displays.

### FIELD OF THE INVENTION

This invention relates to video monitoring systems. In particular, this invention relates to a video monitoring system for viewing multiple video streams.

### BACKGROUND OF THE INVENTION

Often premises, such as land or a building, is monitored by placing cameras around and in the premises to record activity around and in the premises. These cameras are generally video cameras capable or recording near realtime images in either black and white or colour.

These cameras are commonly called CCTV cameras, or closed circuit television cameras. Closed circuit refers to the cameras being on a closed electrical circuit with the viewer or monitor.

Video captured by the cameras is often directed to a common location so that people can view the video captured by a plurality of cameras and monitor the videos for suspicious activity. An organization may have security staff dedicated to monitoring the video streams from the cameras. Staff need to be able to know the location of the cameras they are interested in so that the location of the suspicious activity can be determined.

To monitor a plurality of cameras, the video capture streams from the cameras are displayed on one or more displays, such as LCD panels or CRT displays.

In some video monitoring systems, the video capture streams are gathered at a hub. The video capture streams may be communicated from the cameras to the hub by dedicated cables or by using a network, such as an Ethernet network. A viewing platform such as a data processing device, for example a personal computer (PC), communicates with the hub over a network to access the video streams from the cameras. The PC may obtain additional information about the cameras such as their location, capabilities from the hub and to control cameras by transmitting control information to the hub.

### BRIEF DESCRIPTION OF THE DRAWINGS

In drawings which illustrate by way of example only a preferred embodiment of the invention,

FIG. 1 is a schematic overview of the video monitoring system.

FIG. 2 is a schematic of the viewing system.

FIG. 3A is a representation of 64 video streams being displayed on a video display.

FIG. 3B is a representation of video streams being displayed on five video displays.

### DETAILED DESCRIPTION OF THE INVENTION

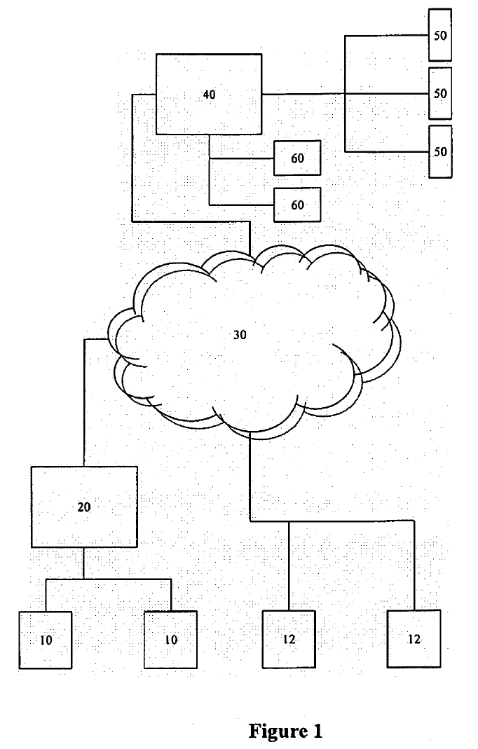

FIG. 1 shows a preferred embodiment of the video monitoring system. Cameras 10, 12, including fixed black and white or colour video cameras, or movable cameras such those with pan, tilt and/or zooming capabilities, are connected to a hub 20. The cameras may be connected directly to the hub 20, as shown for cameras 10. The cameras may alternatively be connected to the hub 20 using a network 30, such as an Ethernet network, as shown for cameras 12. The cameras communicate with the hub using analog signals or digital signals. An IP camera is an example of a camera that may communicate digitally with the hub 20. The communication between the hub 20 and cameras may be unidirectional or bidirectional.

The cameras 10, 12 are typically placed around a premises or property to capture important places, such as entrances or locations with high value property. Cameras 10, 12 typically capture video data and communicate the data to the hub. Depending on the type of camera, the camera may capture a series of still images on a periodic basis. Depending on the rate the still images are captured, the stream of images may appear to be a continuous video stream. The stream of images from the video sources, such as the cameras 10, 12, will be referred to as a video stream regardless of the rate the stream of images is being communicated to the hub or whether the stream is continuous.

The hub 20 is generally connected to the plurality of cameras 10, 12 or other video sources. The hub collects the video streams from the cameras 10, 12. The hub 20 may additionally record the video streams to a storage medium. The hub may be a digital video recorder (DVR). The storage medium may be magnetic, such as tape, or a hard drive. The video streams stored on the storage medium can be reviewed after an incident of interest has occurred on the property being monitored.

The hub 20 communicates one or more of the video streams from the cameras to a computer 40. The computer 40 is typically connected to the hub using a network 30 which may be a local area network (LAN), wide area network (WAN) such as the Internet or a series of networks. The network may be the same network used to connect the cameras 12 and hub 20 or a different network. The network 30 may also be a virtual private network (VPN) which is a virtual network encapsulated over another network such as the Internet.

The data processing device may be a personal computer (PC) 40 or a more specialized computer. The computer 40 has a connection means such as a network adapter 70 for communicating with the hub 20. The computer 40 also has one or more video adapters for communicating video signals to one or more video displays 50. The computer 40 also has one or more controllers 60, such as a keyboard, joystick or other means for controlling the operation of the computer.

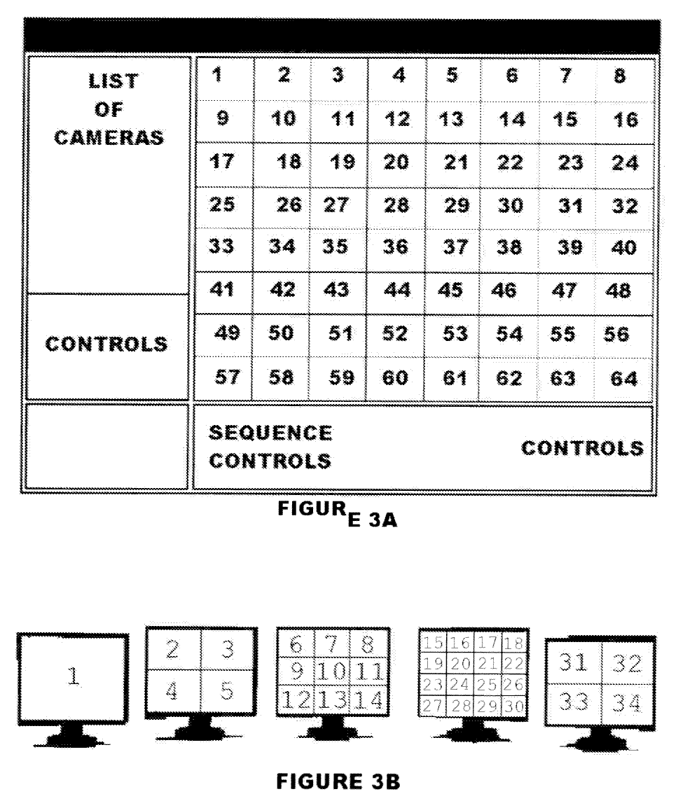

In operation, the computer 40 communicates with the hub 20 to obtain video streams from the cameras 10, 12. The computer 40 may also obtain information about the number, location and capabilities of the cameras 10, 12 from the hub 20. The user of the computer 40 can use the controller 60 to select which of the video streams to display on the video displays 50. A single video stream can be displayed on a single video display 50 or a plurality of video streams can be displayed on a single video display 50. A single video stream may also be displayed on multiple video displays 50. Multiple video streams may be displayed on multiple video displays 50. FIGS. 3A and 3B show representations of video displays displaying a plurality of video streams.

The computer 40 can preferably also control the bandwidth used by the video streams. For example if the available bandwidth is limited, the frame rate of the video streams, the number of frames being sent from the hub to the computer, may be lowered. The computer 40 may be connected to the hub 20 using a VPN, which is one configuration where the size and frame rate of the cameras 10, 12 may be restricted. The size and frame rate of the cameras 10, 12 may be also be restricted by the user's preferences. The size and frame rate of the camera selected by a user may be given priority over other cameras in the system to improve the quality of the selected video stream.

Generally, the more video streams displayed on a single video display the smaller each video stream is shown. The larger the video stream is displayed the easier it is to see and detect changes in the video stream. If a user monitoring a video stream sees something of interest, they may want to enlarge the video stream to better see the details in the video stream.

The computer 40 can determine a layout of the video streams based on the number of cameras supplying video streams. For example, if there are 34 cameras available, the video display can display the video streams on a 36 square grid.

As an example, a first video display may display 64 video streams and a second video display displays four video streams selected from the first 64 video streams. A user monitoring the video streams could select which four video streams should be enlarged and displayed on the second video display.

For cameras with tilt, panning or zooming capabilities, the user can use the controller 60, such as a joystick, gamepad, or mouse, to modify the tilt, panning and/or zoom position of the camera. The computer 40 may communicate with the controller 60 using a protocol such as DirectX.

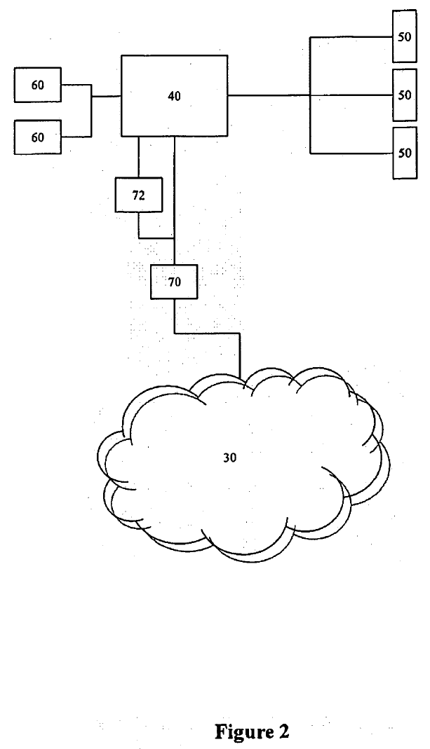

Referring to FIG. 2, the computer 40, is connected to one or more video displays 50. The computer 40 also uses a network adapter 70 to connect to the hub 20 using a network 50. To establish multiple connections with the hub 20, the computer 40 has a second network adapter 72. The second network adapter 72 may be a physical adapter connected directly to the network 50. More preferably, the second network adapter 72 is a virtual loopback network adapter which utilizes the network adapter 70 to connect to the network 50. The virtual loopback network adapter can be utilized by software on the computer 40 as if it was a second network adapter. The loopback adapter uses network address translation (NAT) to translate TCP port assignments from the second network adapter 72 to the network adapter 70.

A second (or more) network adapter 72 can be used to establish a connection with a second hub 20 and obtain video streams associated with cameras associated with the second hub 20. If a hub 20 can support a limited number of cameras, for example 16 cameras, the computer 40 can connect to a second hub 20 to expand the number of sources of video streams. Similarly, the number of virtual network adapters and hubs can be extended. The resources such as memory and network bandwidth may limit the number of video streams, cameras 10, 12 and hubs 20 that the computer 40 can connect to.

Two software programs operating on the computer 40 that attempt to bind to the same TCP port can be configured to connect using the network adapter 70 for the first program and the virtual loopback network adapter 72 for the second program so that both programs can appear to access the same port yet both can access the network without conflict. The programs can be adapted to utilize the network adapters by editing configuration files. Two software programs may also be operated in parallel by establishing directories, registry, memory and other environment properties in order to have both programs operate separately, without direct intercommunication. Establishing environment properties to allow a program to operate properly is typically termed “sandboxing.”

As mentioned above, a single video stream may be displayed on one or more video displays 50. In the preferred embodiment, to obtain multiple copies of the video stream, multiple connections are established with the hub. Properties of a first connection with the hub, including data structures and initialization information, can be duplicated in establishing a second connection and the second connection used to obtain a second video stream from a video camera. The second video stream can then be displayed on a video display.

Various embodiments of the present invention having been thus described in detail by way of example, it will be apparent to those skilled in the art that variations and modifications may be made without departing from the invention.

We claim:

1. A video monitoring system comprising:
one or more video cameras each supplying a video stream;
a hub in communication with the video cameras;
a computer in communication with the hub;
one or more video displays in communication with the computer displaying representations of the one or more video streams;
wherein the representations of the video streams can be arranged on the one or more video displays.
